(19) United States
(12) Patent Application Publication
(10) Pub. No.: US 2017/0178113 A1
(43) Pub. Date: Jun. 22, 2017

(54) SYSTEMS AND METHODS FOR ALLOCATING TRANSACTIONS ACROSS SOURCES

(71) Applicant: CAPITAL ONE SERVICES, LLC, McLean, VA (US)

(72) Inventors: STEPHEN MUGFORD, Wellesley, MA (US); TAMARA SIGLER, Vienna, VA (US); AARON MILLER, Boston, MA (US); KYLE TROMBLEY, Washington, DC (US); JUSTIN CRIST LEE, Cambridge, MA (US); JACK SHU, Arlington, VA (US)

(73) Assignee: Capital One Services, LLC

(21) Appl. No.: 15/380,520

(22) Filed: Dec. 15, 2016

Related U.S. Application Data
(60) Provisional application No. 62/267,989, filed on Dec. 16, 2015.

(51) Int. Cl. G06Q 20/24; G06Q 20/40; G06Q 20/32; G06Q 20/10

(52) U.S. Cl. CPC G06Q 20/24; G06Q 20/102; G06Q 20/40; G06Q 20/3223

(57) ABSTRACT

An exemplary device for allocating transactions across a plurality of sources includes a screen, a memory storing instructions, and a processor configured to execute the instructions to perform operations including: displaying on the screen an interface for a multi-source payment account profile; generating a first window in the interface indicating at least one characteristic of transactions and listing a plurality of potential payment sources available to include in a default allocation of funds settings, the default allocation settings including at least one relative percentage at which the listed payment sources are used to fund transactions; receiving a first user operation adjusting the relative percentages; transmitting the adjusted relative percentages to a server over a communication network; receiving from the server information regarding an approved transaction; and switching the first window to a second window identifying the approved transaction and approved allocation of funds for the approved transaction.

### RELATED APPLICATIONS

This application claims priority from U.S. Provisional Patent Application No. 62/267,989, filed on Dec. 16, 2015, the entire disclosure of which is incorporated by reference in the present application.

### TECHNICAL FIELD

The present disclosure provides a computerized interface for allocating transactions across multiple sources, and a method for generating and configuring the computer interface.

### BACKGROUND

Many situations arise in which customers of financial service providers may wish to fund purchases using multiple payment sources. For example, a customer may wish to make a purchase the customer can only fund using more than one financial account. Indeed, where the payment must be made to the merchant in a single transaction, the customer is unable to complete the purchase because no one account would have sufficient funds available to fund the transaction. Customers may also wish to fund the purchase with a non-transaction based account, such as Home Equity Line of Credit (HELOC) or other form of credit not suitable for point-of-sale purchase.

Some customers, particularly those who are new to credit accounts or are rebuilding their credit, are wary of using their credit accounts because they may spend beyond their means. Thus, such customers typically do not get to enjoy the benefits unique to credit card purchases, such as purchase protection, fraud protection, warranties, loyalty/reward points, etc.

Current systems for processing financial transactions, however, are not equipped to address the technological challenges associated with providing such features sought by customers.

### SUMMARY

The disclosed embodiments may include systems and methods for allocating transactions across a plurality of sources.

In one embodiment, a device for allocating transactions across a plurality of sources is provided. The device may include a screen, a memory storing instructions, and a processor configured to execute the instructions to perform operations. The operations may include displaying on the screen an interface for a multi-source payment account profile. The operations may also include generating a first window in the interface indicating at least one characteristic of transactions and listing a plurality of potential payment sources available to include in a default allocation of funds settings associated with the multi-source payment account profile, the default allocation settings including at least one relative percentage at which the listed payment sources are used to fund transactions with the indicated at least one characteristic. The operations may also include receiving a first user operation adjusting the relative percentages of the listed payment sources. The operations may also include transmitting the adjusted relative percentages to a server over a communication network. The operations may also include receiving from the server information regarding an approved transaction. The operations may further include switching the first window to a second window identifying the approved transaction and approved allocation of funds for the approved transaction.

In another embodiment, a system for allocating transactions across a plurality of sources is disclosed. The system may include a memory storing instructions and a processor configured to execute the instructions to perform operations. The operations may include receiving, over a payment processing network, an electronic transaction authorization request originating from a merchant server. The operations may also include identifying a multi-source payment account profile from among a plurality of multi-source payment account profiles stored in a database based on the received electronic transaction authorization request. The operations may also include identifying a plurality of potential payment sources linked to the multi-source payment account profile based on the received electronic transaction authorization request. The operations may further include determining a response to the received electronic transaction authorization request based on at least the identified plurality of potential payment sources and a purchase amount associated with the received electronic transaction authorization request. The operations may also include transmitting, over the payment processing network, the response to the merchant server.

In another embodiment, a method for allocating transactions across a plurality of sources is disclosed. The method may include receiving, over a payment processing network, an electronic transaction authorization request originating from a merchant server. The method may also include identifying a multi-source payment account profile from among a plurality of multi-source payment account profiles stored in a database based on the received electronic transaction authorization request. The method may also include identifying a plurality of potential payment sources linked to the multi-source payment account profile based on the received electronic transaction authorization request. The method may further include determining a response to the received electronic transaction authorization request based on at least the identified plurality of potential payment sources and a purchase amount associated with the received electronic transaction authorization request. The method may also include transmitting, over the payment processing network, the response to the merchant server.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary environment for allocating transactions across a plurality of sources, consistent with disclosed embodiments.

FIG. 2 is a block diagram of an exemplary system, consistent with disclosed embodiments.

FIG. 3 is a block diagram of an exemplary computing device, consistent with disclosed embodiments.

FIG. 4 is a flowchart of an exemplary process for allocating transactions across a plurality of sources, consistent with disclosed embodiments.

FIG. 5 is a flowchart of an exemplary process for configuring a multi-source transaction profile, consistent with disclosed embodiments.

FIG. 6 is a flowchart of an exemplary process for responding to a transaction request and allocating funds for the underlying purchase, consistent with disclosed embodiments.

FIG. 7 is a schematic diagram illustrating an exemplary interface on a computing device, consistent with disclosed embodiments.

FIG. 8 is a schematic diagram illustrating another exemplary interface on a computing device, consistent with disclosed embodiments.

FIG. 9A is a schematic diagram illustrating another exemplary interface on a computing device, consistent with disclosed embodiments.

FIG. 9B is a schematic diagram illustrating another exemplary interface on a computing device, consistent with disclosed embodiments.

FIG. 10 is a schematic diagram illustrating another exemplary interface on a computing device, consistent with disclosed embodiments.

FIG. 11A is a schematic diagram illustrating another exemplary interface on a computing device, consistent with disclosed embodiments.

FIG. 11B is a schematic diagram illustrating another exemplary interface on a computing device, consistent with disclosed embodiments.

### DETAILED DESCRIPTION

Reference will now be made in detail to the disclosed embodiments, examples of which are illustrated in the accompanying drawings.

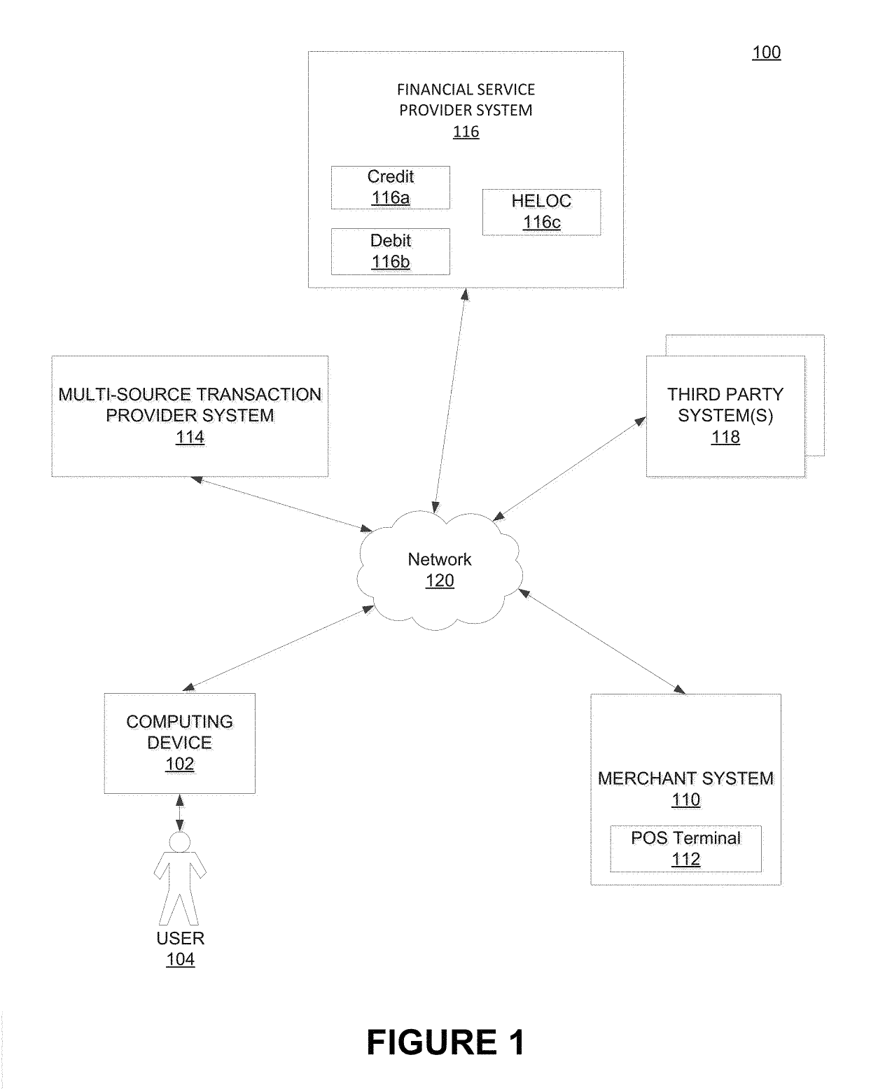

FIG. 1 is a block diagram of an exemplary system 100, consistent with disclosed embodiments. In particular, system 100 may be configured for performing one or more operations consistent with the disclosed embodiments. In one embodiment, system 100 may include computing device 102 associated with user 104, a merchant system 110 having a Point-of-Sale (POS) terminal 112, a multi-source transaction provider system 114, a financial service provider (FSP) system 116, and third-party system(s) 118, all of which may be communicatively coupled by a network 120.

While only a single computing device 102, merchant system 110, multi-source transaction provider system 114, FSP system 116, and network 120 are shown, it will be understood that system 100 may include more than one of any of these components. Still further, while multiple third-party systems 118 are shown, it will be understood that system 100 may include only one third-party system 118. The components and arrangement of the components included in system 100 may vary. Thus, system 100 may include other components that perform or assist in the performance of one or more processes consistent with the disclosed embodiments.

Multi-source transaction provider system 114 may be configured to allocate the cost of a purchase across a plurality of funding sources for user 104. Multi-source transaction provider system 114 may facilitate the allocation of a purchase across a plurality of funding sources by, for example, coordinating with FSP system 116 after receiving a transaction authorization request from merchant system 110. For example, FSP system 116 may forward transaction authorization requests from merchant system 110, and multi-source transaction provider system 114 may provide responses to the transaction authorization requests through FSP system 116 and coordinate with FSP system 116 regarding the appropriate reconciliation of accounts used as payment sources to fund the underlying purchases. In other embodiments, multi-source transaction provider system 114 may receive and/or respond to transaction authorization requests directly.

In some embodiments, user 104 may access multi-source transaction provider system 114 using computing device 102 to, for example, configure a multi-source payment account profile and/or modify the allocation of funds. For example, computing device 102 may be configured to execute a mobile application provided by multi-source transaction provider system 114. To this end, multi-source transaction provider system 114 may provide particular interfaces to computing device 102, thereby enabling user 104 to interact with the interfaces, configure a multi-source payment account profile, modify the allocation of funds, and/or employ additional features consistent with disclosed embodiments. Multi-source transaction provider system 114 may facilitate allocation of a purchase across a plurality of funding sources in other manners as well, as discussed below.

Merchant system 110 may comprise one or more computing devices configured to perform one or more operations consistent with disclosed embodiments. For example, merchant system 110 can be a computing device that is controlled and operated by a merchant that provides products (e.g., goods and/or services), such as a restaurant (e.g., Outback Steakhouse®, Burger King®, etc.), retailer (e.g., Amazon.com®, Target®, etc.), grocery store, service provider (e.g., utility company, insurance company, financial service provider, automobile repair services, etc.), or any other type of entity that provides goods, services, and/or information that consumers (i.e., end-users or other business entities, such as user 104) can purchase, consume, use, etc.

Merchant system 110 can include a POS terminal, which can be a dedicated POS terminal (e.g., POS Terminal 112), or a software application that can configure a mobile computing device to accept financial account card payments. For example, a software application can configure a mobile computing device to interface with an input device connected to the mobile computing device. The input device can include a terminal or port that accepts data financial account card data.

In some embodiments, merchant system 110 can provide line-item data describing the items that are included in a given transaction to other components of system 100. For example, if user 104 engaged in a transaction with a merchant associated with merchant system 110, merchant system 110 may transmit a transaction authorization request to FSP system 116 that indicates, e.g., the merchant name and location, the item(s) being purchased, the user's financial data, or any other data associated with the purchase and/or transaction authorization request.

FSP system 116 may be associated with a financial service entity that provides, maintains, manages, or otherwise offers financial services. For example, the financial service entity may be a bank, credit card issuer, or any other type of financial service entity that generates, provides, manages, and/or maintains financial service accounts for one or more customers. Financial service accounts may include, for example, credit card accounts, loan accounts, line-of-credit account, checking accounts, savings accounts, reward or loyalty program accounts, prepaid card accounts, and/or any other type of financial service account known to those skilled in the art.

FSP system 116 may be one or more computing devices configured to perform operations consistent with maintaining financial service accounts, including a financial service account associated with user 104. FSP system 116 may be further configured to generate content for a display device included in, or connected to, computing device 102. For example, FSP system 116 may provide content through a mobile banking application on computing device 102. Alternatively or additionally, FSP system 116 may provide content through one or more web sites or online portals that are accessible by computing device 102 over network 120. FSP system 116 may be one or more computing devices. In particular, FSP system 116 may be configured to authenticate financial transactions associated with financial service account(s) of user 104. The disclosed embodiments are not limited to any particular configuration of FSP system 116.

FSP system 116 may include a plurality of servicing platforms. For example, FSP system 116 may include a credit servicing platform 116a for providing, maintaining, managing, or otherwise offering credit accounts. In some embodiments, credit servicing platform 116a may process, authorize, release funds, accept funds, update credit balances, and otherwise service transaction requests, such as purchases made with a credit card account. FSP system 116 may also include a debit servicing platform 116b for providing, maintaining, managing, or otherwise offering debit accounts. In some embodiments, debit servicing platform 116b may process, authorize, release funds, accept funds, update account balances, and otherwise service transaction requests, such as purchases made with a debit card account. FSP system 116 may also include a Home Equity Line of Credit (HELOC) servicing platform 116c for providing, maintaining, managing, or otherwise offering HELOC accounts. In some embodiments, HELOC servicing platform 116c may process, authorize, release funds, accept funds, update account balances, and otherwise service transaction requests associated with offering a line of credit. Other servicing platforms for carrying out debit and/or credit transactions are possible.

Servicing platforms associated with FSP system 116, including credit servicing platform 116a, debit servicing platform 116b, and/or HELOC servicing platform 116c may be implemented in hardware, software, or a combination of both hardware and software, as will be apparent to those skilled in the art. For example, although servicing platforms associated with FSP system 116 (shown and not shown) may be implemented as computer processing instructions, all or a portion of the functionality of the servicing platforms may be implemented instead in dedicated electronics hardware.

Third-party systems 118 may include one or more computing systems configured to perform one or more operations consistent with facilitating electronic payment by user 104. To this end, third-party systems 118 may be configured to execute instructions to perform one or more processes facilitating the electronic transfer of funds between financial service accounts associated with user 104, which in some embodiments may include reconciling the financial service accounts used as payment sources to fund a purchase. This may occur as a direct transfer (within the same institution) or through ACH (between institutions), among other possible transaction types. In some embodiments, third-party system(s) 118 may be additional financial service provider systems associated with, for example, a financial service provider other than the one associated with FSP system 116. In some embodiments, third-party system(s) 118 may include a system similar to, for example, PayPal® (see https://https://www.paypal.com/), Google Wallet™ (see https://www.google.com/wallet/), or Dwolla™ (see https://www.dwolla.com/). Third-party system(s) 118 may also be configured to execute instructions to perform one or more processes regarding creditworthiness. For example, third-party system(s) 118 may be associated with an entity concerned with determining the credit risk associated with current or potential customers of a financial service provider. Third-party system(s) 118 may take other forms as well, and the disclosed embodiments are not limited to any particular configuration of third-party system(s) 118.

While multi-source transaction provider system 114, FSP system 116, and third-party system(s) 118 are shown separately, in some embodiments FSP system 116 may include or be otherwise related to one or both of multi-source transaction provider system 114 and/or third-party system(s) 118. For example, in some embodiments, multi-source transaction provider system 114 may comprise a component of FSP system 116 integrated similar to credit servicing platform 116a, debit servicing platform 116b, and/or HELOC servicing platform 116c. Other examples are consistent with the disclosed embodiments.

Network 120 may be any type of network configured to provide communication between components of system 100. For example, network 120 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

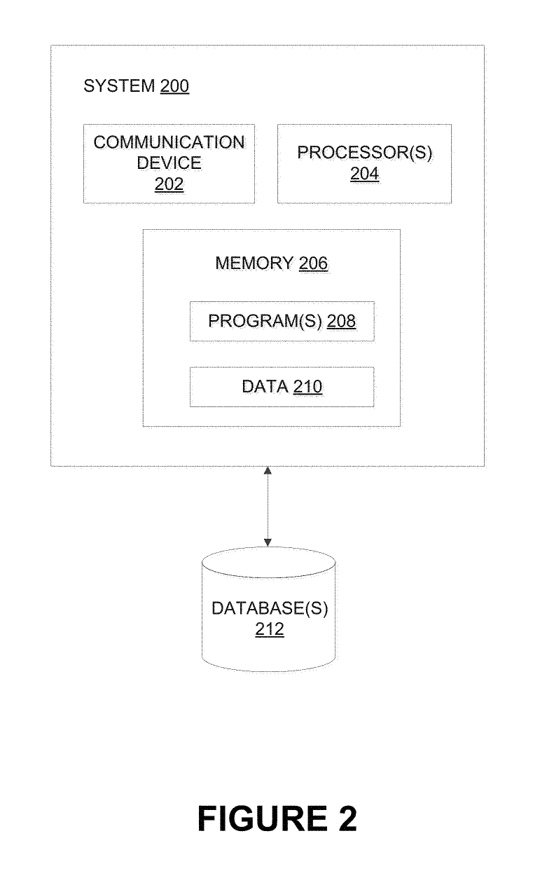

FIG. 2 is a block diagram of an exemplary system 200 that may be employed by one or more components of system 100, consistent with disclosed embodiments. For example, FSP system 116, multi-source transaction provider system 114, third party system(s) 118, merchant system 110, and/or computing device 102 may include system 200, or variants thereof, to perform operations consistent with disclosed embodiments.

As shown, system 200 may include communication device 202, one or more processor(s) 204, and memory 206 including one or more programs 208 and data 210. In some embodiments, system 200 may take the form of a server, general purpose computer, mainframe computer, or any combination of these components. Other implementations consistent with disclosed embodiments are possible.

Communication device 202 may be configured to communicate with other components of system 100. Communication device 202 may be configured to provide communication over a network, such as network 120 described above. For example, system 200 may include one or more digital and/or analog devices that allow system 200 to communicate with other components of system 100, such as a network controller and/or wireless adaptor for communicating over the Internet. Other implementations consistent with disclosed embodiments are possible as well.

Processor(s) 204 may include one or more known processing devices, such as a microprocessor from the Pentium™ or Xeon™ family manufactured by Intel™, the Turion™ family manufactured by AMD™, or any of various processors manufactured by Oracle™, for example. The disclosed embodiments are not limited to any type of processor(s) otherwise configured to meet the computing demands required of different components of FSP system 116, multi-source transaction provider system 114, third party system(s) 118, merchant system 110, and/or computing device 102.

Memory 206 may include one or more storage devices configured to store instructions used by processor(s) 204 to perform functions related to disclosed embodiments. For example, memory 206 may be configured with one or more software instructions, such as program(s) 208, that may perform one or more operations when executed by processor(s) 204. The disclosed embodiments are not limited to separate programs or computers configured to perform dedicated tasks. For example, memory 206 may include a single program 208 that performs the functions of system 200, or program(s) 208 may comprise multiple programs. Memory 206 may also store data 210 that is used by program(s) 208.

The components of system 200 may be implemented in hardware, software, or a combination of both hardware and software, as will be apparent to those skilled in the art. For example, although one or more components of system 200 may be implemented as computer processing instructions, all or a portion of the functionality of system 200 may be implemented instead in dedicated electronics hardware.

System 200 may also be communicatively connected to one or more database(s) 212. In one aspect, system 200 may include database(s) 212. Alternatively, database(s) 212 may be located remotely from system 200. System 200 may be communicatively connected to database(s) 212 through a network, such as network 120 described above. Database(s) 212 may include one or more memory devices that store information and are accessed and/or managed through system 200. By way of example, database(s) 212 may include Oracle™ databases, Sybase™ databases, or other relational databases or non-relational databases, such as Apache™ Hadoop® sequence files (see https://wiki.apache.org/hadoop/SequenceFile), Apache™ HBase™ (Hadoop® Database, see https://hbase.apache.org/), or Apache™ Cassandra (see http://cassandra.apache.org/). Database(s) 212 may include computing components (e.g., database management system, database server, etc.) configured to receive and process requests for data stored in memory devices of database(s) 212 and to provide data from database(s) 212.

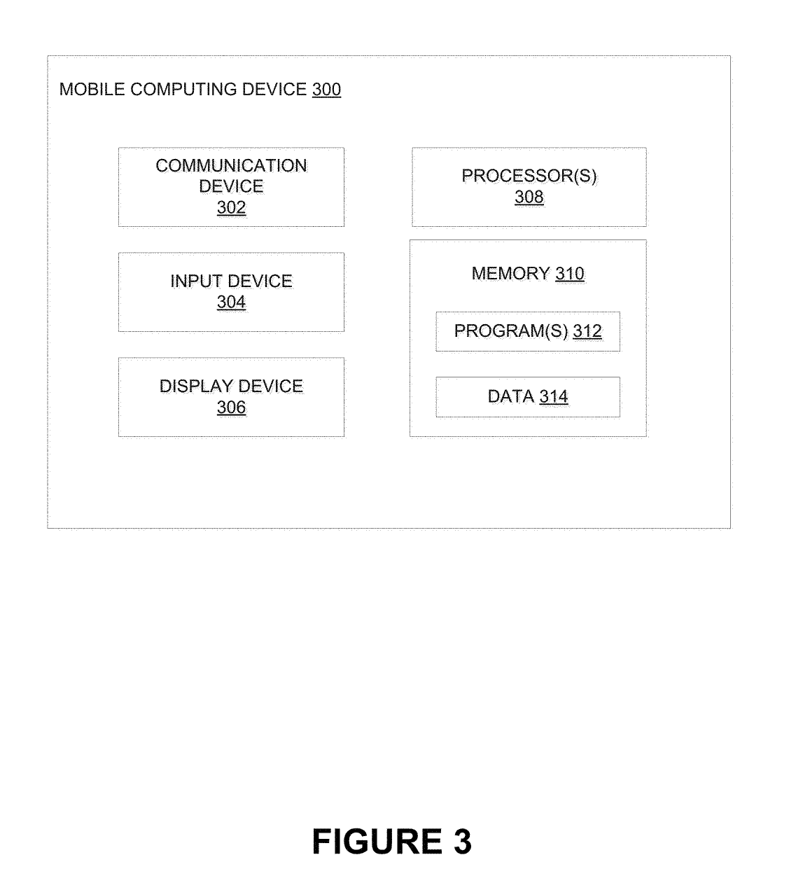

FIG. 3 is a block diagram of an exemplary mobile computing device 300, consistent with disclosed embodiments. As shown, mobile computing device 300 includes communication device 302, input device 304, display 306, processor(s) 308, and memory 310 including program(s) 312 and data 314. For example, FSP system 116, multi-source transaction provider system 114, third party system(s) 118, merchant system 110, and/or computing device 102 may include mobile computing device 300, or variants thereof, to perform operations consistent with disclosed embodiments.

In some embodiments, mobile computing device 300 may take the form of a smartphone, tablet, laptop computer, or any combination of these components. Alternatively, mobile computing device 300 may be configured as any wearable item, including jewelry, smart glasses, a watch, or any other device suitable for carrying or wearing on a customer's person. Other implementations consistent with disclosed embodiments are possible as well.

Communication device 302 may be configured to communicate with FSP system 116, multi-source transaction provider system 114, third party system(s) 118, merchant system 110, and/or computing device 102, described above. Communication device 302 may be configured to provide communication over a network, such as networks 120 described above. To this end, communication device 302 may include, for example, one or more digital and/or analog devices that allow mobile computing device 300 to communicate with other components, such as a network controller and/or wireless adaptor for communicating over the Internet. Other implementations consistent with disclosed embodiments are possible as well.

Input device 304 may be configured to receive input from a user. For example, when operated by user 104 when implemented as computing device 102, input device 304 may be configured to receive one or more user input for configuring a multi-source payment account profile, modifying the allocation of funds, and/or employ other features consistent with disclosed embodiments. Input device 304 may be configured to receive other information as well. Input device 304 may take the form of, for example, touch-sensitive area, keyboard, buttons, or microphones. Other input devices are possible as well. The disclosed embodiments are not limited to any type of input devices otherwise configured to receive input from a user.

Display device 306 may be any display device configured to display interfaces on mobile computing device 300. In some embodiments, display device 306 may include a screen for displaying a graphical and/or text-based user interface, including but not limited to, liquid crystal displays (LCD), light emitting diode (LED) screens, organic light emitting diode (OLED) screens, and other known display devices. In some embodiments, display device 306 may also include one or more digital and/or analog devices that allow a user to interact with mobile computing device 300, such as a touch-sensitive area, keyboard, buttons, or microphones. In some embodiments, display device 306 may be implemented together with input device 304. Other display devices are possible as well. The disclosed embodiments are not limited to any type of display devices otherwise configured to display interfaces.

Processor(s) 308 may include one or more known processing devices, such as a microprocessor from the Pentium™ or Xeon™ family manufactured by Intel™, the Turion™ family manufactured by AMD™, or any of various processors manufactured by Oracle™, for example. Processor(s) 308 may also include various architectures (e.g., x86 processors (by various manufactures, such as Intel™ and AMD™), ARM® processors (see https://www.arm.com/products/processors), etc.). The disclosed embodiments are not limited to any type of processor(s) otherwise configured to meet the computing demands required of different components of mobile computing device 300.

Memory 310 may include one or more storage devices configured to store instructions used by processor(s) 308 to perform functions related to disclosed embodiments. For example, memory 310 may be configured with one or more software instructions, such as program(s) 312, that may perform one or more operations when executed by processor(s) 308. The disclosed embodiments are not limited to separate programs or computers configured to perform dedicated tasks. For example, memory 310 may include a single program 312 that performs the functions of mobile computing device 300, or program(s) 312 may comprise multiple programs. Memory 310 may also store data 314 that is used by program(s) 312.

In some embodiments, memory 310 may store instructions for executing program(s) 312 in the form of one or more mobile applications. The mobile applications may include, for example, a multi-source transaction application allowing user 104 to configure a multi-source payment account profile, modify the allocation of funds, and/or employ other features consistent with disclosed embodiments. The mobile applications may further include, for example, a mobile banking application for providing financial service-related functions offered by an FSP system, such as FSP system 116. These functions may include, for instance, checking balances, paying bills, performing financial transactions, budgeting, receiving marketing messages, etc. Other mobile applications are possible as well. In still other embodiments, a single application may provide all the above-disclosed features of programs(s) 312 and be provided by the same entity (e.g., via multi-source transaction provider system 114 or FSP system 116). In general, instructions may be executed by processor(s) 308 to perform one or more processes consistent with disclosed embodiments.

Components of mobile computing device 300 may be implemented in hardware, software, or a combination of both hardware and software, as will be apparent to those skilled in the art. For example, although one or more components of mobile computing device 300 may be implemented as computer processing instructions, all or a portion of the functionality of mobile computing device 300 may be implemented instead in dedicated electronics hardware.

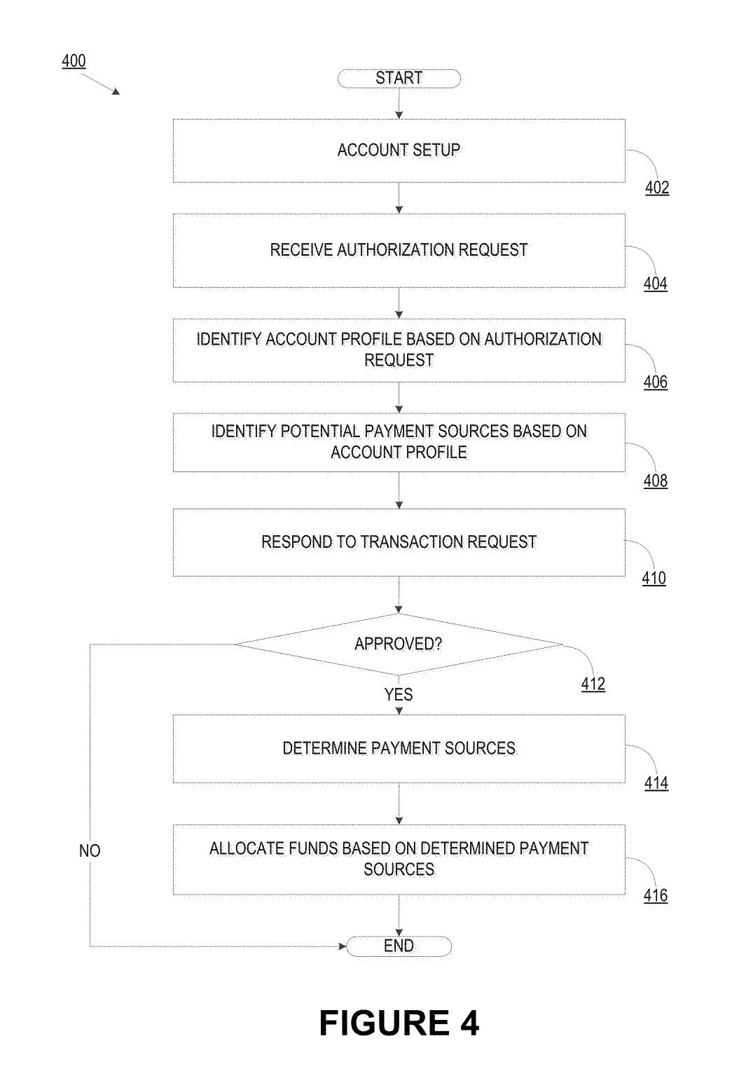

FIG. 4 is a flowchart of an exemplary process 400 for allocating transactions across a plurality of payment sources. Process 400 may be carried out, for example, by multi-source transaction provider system 114, described above. It should be understood, however, that one or more steps of process 400 may be carried out by other components of system 100.

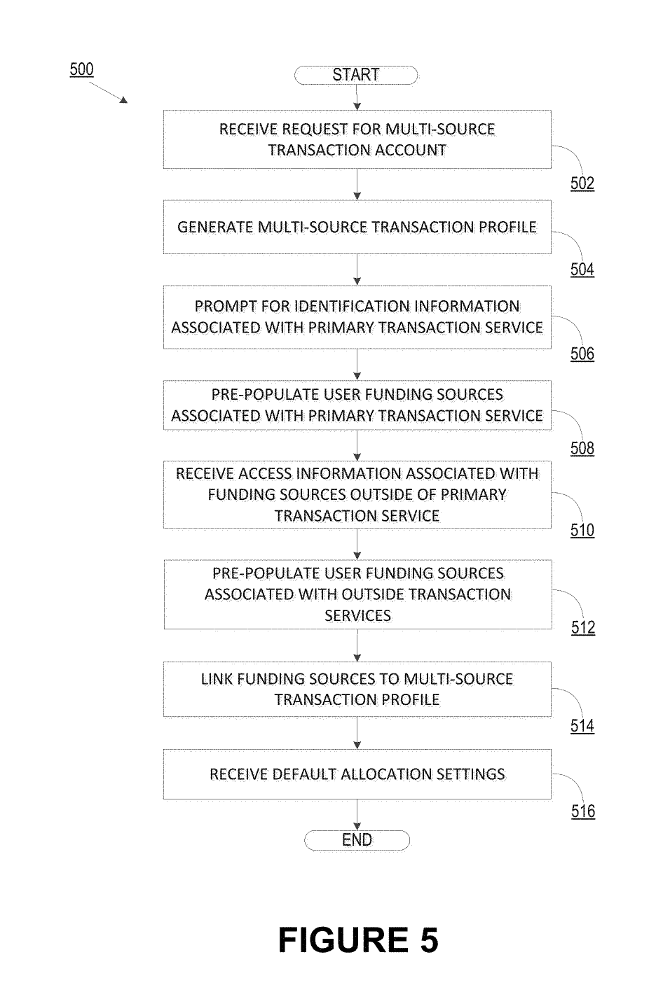

At step 402, multi-source transaction provider system 114 may configure a multi-source payment account profile associated with a user, such as user 104. For example, multi-source transaction provider system 114 may generate a multi-source payment account profile linked to a plurality of financial service accounts of user 104 that includes default allocation settings provided by user 104. Additional details regarding configuration of the multi-source payment account profile are provided below with respect to process 500 of FIG. 5.

At step 404, multi-source transaction provider system 114 may receive a transaction authorization request. The transaction authorization may be received in real time, e.g., as the associated transaction occurs. For example, user 104 may initiate a purchase with a merchant associated with merchant system 110 (by, for example, using a financial service product at POS Terminal 112), and merchant system 110 may request authorization to process the payment. In some embodiments, merchant system 110 may transmit the transaction authorization request directly to multi-source transaction provider system 114. In other embodiments, merchant system 110 may transmit the transaction authorization request to FSP system 116, and FSP system 116 may communicate the transaction authorization request to multi-source transaction provider system 114.

At step 406, multi-source transaction provider system 114 may identify a multi-source payment account profile associated with user 104. For example, multi-source payment account profile may extract information from the transaction authorization request unique to user 104, such as a financial account number of user 104 provided to POS terminal 112 of merchant system 112 in order to complete the purchase. In some embodiments, multi-source transaction provider system 114 may access a database (e.g., database 212) storing a plurality of multi-source payment account profiles to determine that the financial account number of user 104 is linked to user 104's multi-source payment account profile. In other embodiments, the transaction authorization request may include unique identification information provided to user 104 by multi-source transaction provider system 114. For example, multi-source transaction provider system 114 may generate unique identification information during step 402 that user 104 provided merchant system 110 to complete the purchase. In some embodiments, the unique identification information may be an account number embodied on a financial account product provided by an entity operating multi-source transaction provider system 114 to use for multi-source transactions. In other embodiments, the unique identification information may be a primary account number (PAN) for a financial account provided to user 104 by a financial service provider associated with FSP system 116.

At step 408, multi-source transaction provider system 114 may identify potential payment sources for completing the purchase transaction. For example, multi-source transaction provider system 114 may identify a plurality of payment sources linked to the multi-source payment account profile identified at step 406. The payment sources may include, for example, one or more checking accounts, savings accounts, retirement accounts, investment accounts, credit card accounts, personal loan accounts, personal lines of credit, home equity lines of credit (HELOC), loyalty or reward program accounts (including point balance-based accounts), prepaid or gift card accounts or other “stored value” accounts, accounts associated with a person-to-person (P2P) payments platform (e.g., PayPal®, Venmo® (see https://venmo.com/), Square® Cash (see https://cash.me/), PopMoney® (see https://www.popmoney.com/), etc.), or any other transaction or non-transaction based mechanism for storing or transmitting funds.

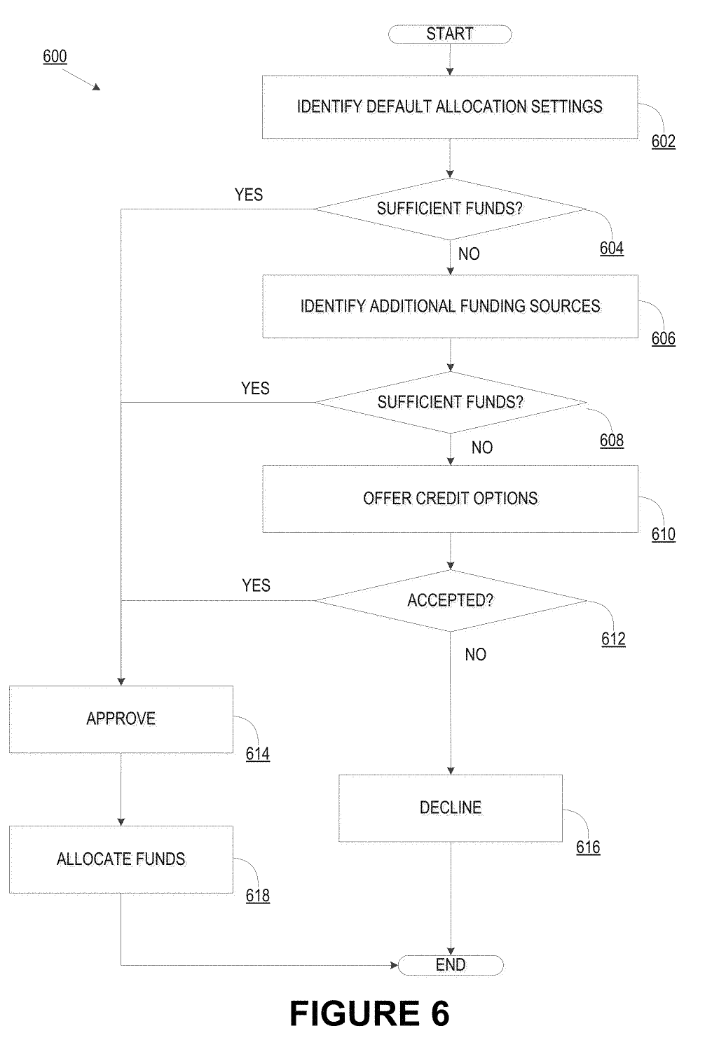

At step 408, multi-source transaction provider system 114 may respond to the transaction authorization request. For example, multi-source transaction provider system 114 may approve the request based on a determination that the potential payment sources identified in step 408 sufficiently fund the purchase associated with the transaction authorization request. Additional detail regarding multi-source transaction provider system 114's response to the transaction authorization request may be found below with respect to process 600 associated with FIG. 6.

As noted above, in some embodiments, multi-source transaction provider system 114 may respond directly to merchant system 110, thereby initiating completion of the purchase transaction. In other embodiments, multi-source transaction provider system 114 may provide the response to FSP system 116, which may in turn forward the response to merchant system 110 (with or without alteration).

If the transaction authorization request is declined (step 412; NO), the process may end. On the other hand, if the transaction authorization request is approved (step 412; YES), multi-source transaction provider system 114 may determine which of the payment sources (step 414) from among the potential payment sources identified in step 408 should be used to fund the purchase. In some embodiments, user 104's multi-source payment account profile may include default allocation settings that define the default allocation of funds from among the identified of potential payment sources for the purchase. Additionally or alternatively, multi-source transaction provider system 114 may determine which of the payment sources should be used to fund the purchase allocations based on, for example, a determination that the user would qualify for a special promotion or other benefit by using a particular payment source or type of payment method. For example, multi-source transaction provider system 114 may determine that using a particular linked payment source to fund a transaction with the merchant associated with the received transaction request would qualify the user for some other promotional offer (additional reward points, a purchase price discount, etc.). Additional details regarding payment source determination are described below with respect to process 600 of FIG. 6.

At step 416, multi-source transaction provider system 114 may allocate the funds among the determined payment sources to cover the purchase underlying the transaction authorization request. For example, multi-source transaction provider system 114 may initiate reconciliation of the determined payment sources to fund the purchase according to the default allocation of funds. In some embodiments, reconciliation of the determined payment sources may include interfacing a plurality of separate servicing platforms (e.g., credit servicing platform 116a, debit servicing platform 116b, and/or HELOC servicing platform 116c) to coordinate the transfer of funds from the funding source(s) serviced by each platform as determined by multi-source transaction provider system 114. In some examples, reconciliation of the determined payment sources may happen simultaneously with the transaction request, while in other examples, reconciliation may be delayed and payment sources may be adjusted by user 104 and/or FSP system 116 prior to reconciliation.

For example, in some embodiments, multi-source transaction provider system 114 may coordinate the debit (for debit accounts via debit service platform 116b) and/or credit (for credit accounts via credit service platform 116a) of the payment sources in proportion to user 104's default settings for funding the purchase. In some examples, all the determined payment sources may be managed by a single financial service provider, such as a financial service provider associated with FSP system 116. In other examples, however, at least one of the determined payment sources may be managed by one or more other financial service providers, such as financial service provider(s) associated with third party system(s) 118. For example, if user 104 requests to share the transaction expense with another person, the funding may be managed by a P2P platform and multiple financial service providers.

FIG. 5 is a flowchart of an exemplary process 500 for configuring a multi-source transaction profile, consistent with disclosed embodiments. Process 500 may be carried out, for example by multi-source transaction provider system 114, described above. It should be understood, however, that one or more steps of process 500 may be carried out by other components of system 100, such as computing device 102.

At step 502, multi-source transaction provider system 114 may receive a request to generate a multi-source transaction account. For example, user 104 may operate computing device 102 to communicate with multi-source transaction provider system 114 to make the request. In some embodiments, the request may include identifying information for user 104 (e.g., name, address, etc.).

At step 504, multi-source transaction provider system 114 may generate a multi-source transaction profile based on the request. In some embodiments, multi-source transaction provider system 114 may generate a username, profile/account number, or other identification uniquely identifying user 104 with respect to other multi-source transaction profiles. In some embodiments, multi-source transaction provider system 114 may store the generated profile in a database, such as database 212.

At step 506, multi-source transaction provider system 114 may prompt user 104 for identification information associated with a primary transaction service, such as a financial service provider associated with FSP system 116. For example, multi-source transaction provider system 114 may transmit instructions to computing device 102 for displaying an interface on computing device 102 requesting the identification information associated with a primary transaction service or any other information associated with setting up a multi-source transaction profile. In some embodiments, the identification information associated with a primary transaction service may comprise access credentials to FSP system 116 for accessing funding sources (e.g., financial service accounts) of user 104.

At step 508, multi-source transaction provider system 114 may populate information associated with the primary transaction service for user 104's multi-source transaction profile, such as the particulars of all funding sources associated with the primary transaction service. For example, if user 104 holds one checking account, two credit card accounts, and a Home Equity Line of Credit (HELOC) with the primary transaction service, multi-source transaction provider system 114 may load information associated with those accounts (e.g., account numbers, routing numbers, current balances, credit limits, etc.) into a pre-populated form for user 104 to view and confirm (via, e.g., computing device 102).

At step 510, multi-source transaction provider system 114 may receive access credentials for accessing funding sources outside the primary transaction service. For example, multi-source transaction provider system 114 may transmit instructions to computing device 102 for displaying an interface on computing device 102 requesting access credentials associated with any additional transaction services for which user 104 holds a funding source the user wishes to associated with the multi-source transaction profile. In response, user 104 may operate computing device 102 to transmit the requested information to multi-source transaction provider system 114.

At step 512, multi-source transaction provider system 114 may pre-populate information associated with the additional transaction services for user 104's multi-source transaction profile. For example, if user 104 holds an additional checking account and a personal line of credit with the additional transaction services, multi-source transaction provider system 114 may load information associated with those accounts (e.g., account numbers, routing numbers, current balances, credit limits, etc.) into a pre-populated form for user 104 to view and confirm (via, e.g., computing device 102).

At step 514, multi-source transaction provider system 114 may link the funding sources identified in steps 506-512 to user 104's multi-source transaction profile. For example, multi-source transaction provider system 114 may identify the linked funding sources as the potential payment sources at step 408.

At step 516, multi-source transaction provider system 114 may receive default allocation settings associated with the multi-source transaction profile. In some embodiments, the default allocation settings may include identification of a particular account(s) associated with the primary transaction service (e.g., identified at step 506) whose use to make a purchase or other transaction (e.g., by using a card to make a payment at POS Terminal 112) would initiate process 400 and/or other disclosed embodiments. In some embodiments, the default allocation settings may be limited to certain transaction categories (e.g., payments under $100, restaurant transactions, etc.) designated by user 104. Alternatively or additionally, different default allocation settings may be used for different transaction categories, such that a funding allocation can be differentiated based on transaction categories. As another example, the default settings may be set by a user before one or more known upcoming transactions, e.g., all the transactions during a planned trip.

In some embodiments, multi-source transaction provider system 114 may transmit instructions to computing device 102 for displaying an interface on computing device 102 requesting identification of which potential payment sources should be used, and in what relative amounts, to fund different purchases. For example, computing device 102 may display an interface for receiving default allocation settings associated with transactions below $100. A user (e.g., user 104) may operate computing device 102 to indicate that all transactions below $100 are funded entirely by a checking account associated with the user. Thus, in embodiments where use of the primary account number (PAN) for a credit card account associated with multi-source transaction profile initiates process 400 (or other disclosed embodiments), the purchase may be processed by FSP system 116 and merchant system 110 as a credit card transaction even though funded by a debit card transaction. Regardless, computing device 102 may, in turn, transmit the user-inputted default allocation settings to multi-source transaction provider system 114 for association to the user's multi-source transaction profile.

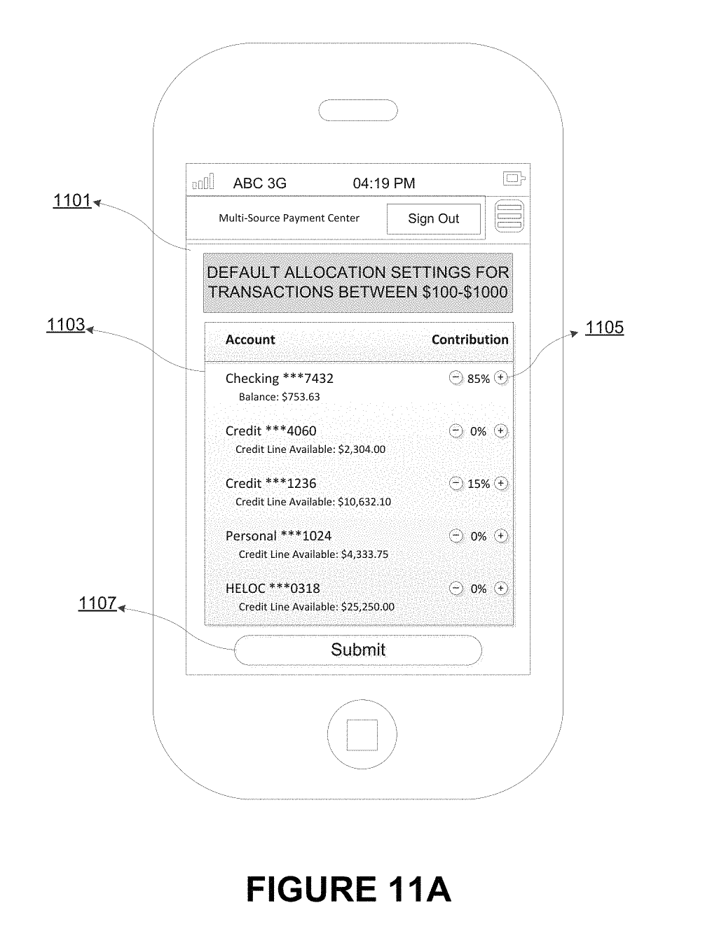

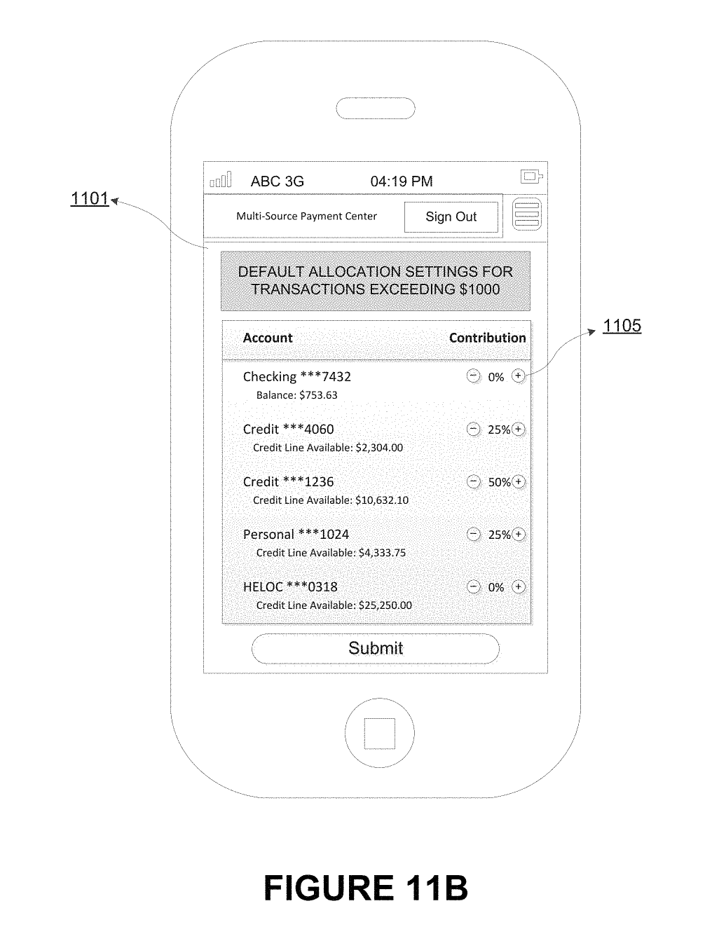

In another example, FIG. 11A depicts an exemplary user interface 1101 on computing device 102. As shown in FIG. 11A, computing device 102 may display interface 1101 to receive default allocation settings associated with transactions between $100 and $1000. Interface 1101 may include window 1103 listing potential payment sources available to include in the default allocation settings. Window 1103 may identify any number of checking accounts, savings accounts, retirement accounts, investment accounts, credit card accounts, personal loan accounts, personal lines of credit, home equity lines of credit (HELOC), loyalty or reward program accounts (including point balance-based accounts), prepaid or gift card accounts or other “stored value” accounts, accounts associated with a person-to-person (P2P) payments platform (e.g., PayPal®, Venmo®, Square® Cash, PopMoney®, etc.), and/or any other payment sources linked to a user's multi-source transaction profile as described in step 514. In some embodiments, window 1103 may indicate the funds currently available for each identified potential payment source, if available. For example, for debit accounts, window 1103 may indicate the account balance at the time of identifying the default allocation settings. Similarly, for credit accounts, window 1103 may indicate the remaining credit available for each credit account to fund purchases at the time of identifying the default allocation settings. Interface 1101 may additionally include buttons 1105 (or other selectable elements) for adjusting the relative percentage that each funding source should be used to fund purchases between $100 and $1000. In the example interface 1101 depicted in FIG. 11A, a user (e.g., user 104) has operated computing device 102 to indicate that account “Checking ***7432” should fund 85% of such purchases, while account “Credit ***1236” should be used to fund the remaining 15% of those purchases. Interface 1101 may also include a “submit” button 1107 that, when selected, causes computing device 102 to transmit the default allocation settings to multi-source transaction provider system 114 for association to the user's multi-source transaction profile.

In another example, FIG. 11B depicts another exemplary user interface 1101 on computing device 102. As shown in FIG. 11B, computing device 102 may display interface 1101 to receive default allocation settings associated with transactions above $1000. As shown in the example interface 1101 depicted in FIG. 11B, a user (e.g., user 104) may operate computing device 102 to indicate that account “Credit ***4060” should fund 25% of purchases over $1000, account “Credit ***1236” should be used to fund 50% of those purchases, and a personal line of credit (account “Personal ***1024”) should be used to fund the remaining 25% of those purchases.

The default allocation settings discussed above with respect to step 516 and FIGS. 11A and 11B are exemplary only. Fewer, different, or additional default allocation settings may be associated with user's multi-source transaction profile, consistent with disclosed embodiments. In some embodiments, different default settings may be used for different transaction categories. For example, default allocation settings may distinguish which potential payment sources should be used, and in what relative amounts, to fund different purchases based on the transaction type and/or any other distinguishing feature discernable from a transaction authorization request. For example, a user (e.g., user 104) may operate computing device 102 to indicate that purchases associated with home improvement retailers (e.g., Home Depot®, LOWE'S®, etc.) should be funded fully by a Home Equity Line of Credit (HELOC) identified among the user 104's potential payment sources linked to the user 104's multi-source transaction profile. Additionally or alternatively, a user (e.g., user 104) may operate computing device 102 to indicate that purchases associated with time thresholds (e.g., occurring during a date range, occurring during specific hours of the day, etc.), geographic locations (e.g., occurring at a location outside a pre-defined radius of a home address, a particular city, state or zip code, etc.), nature of transaction (e.g., swipe card at POS, use of a mobile wallet, online purchase, etc.), or any other classification of transaction or combination of the above. For example, the user may configure default allocation settings to identify specific potential payment sources to use, and in what relative amounts, to fund purchases occurring in a specific geographic area during the time frame that the user is on vacation in the geographic area. As another example, in anticipation an upcoming event (e.g., vacation in Hawaii), the user may set specific funding parameters used for transactions during the event before it occurs. Indeed, the default allocation settings may provide for the suspension or disablement of one or more default allocation settings and/or payment sources. For example, in one embodiment, a user may operate computing device 102 to indicate that one or more default allocation settings and/or payment sources should become suspended upon exceeding a specified spending limit or other threshold. Alternatively or additionally, a user may operate computing device 102 to manually disable one or more payment sources when, for example, a transaction card associated with the one or more payment sources becomes lost or stolen.

FIG. 6 is a flowchart of an exemplary process 600 for responding to a transaction request and allocating funds for the underlying purchase, consistent with disclosed embodiments. Process 600 may be carried out, for example by multi-source transaction provider system 114, described above. It should be understood, however, that one or more steps of process 600 may be carried out by other components of system 100. In some embodiments, one or more steps of process 600 may relate to steps 410-416 of process 400. Consistent with the disclosed embodiments, some or all of the steps in process 600 may be carried out in real time, e.g., as a transaction occurs.

At step 602, multi-source transaction provider system 114 may identify default allocation settings associated with a multi-source payment account profile (e.g., the account profile identified at step 406). For example, multi-source transaction provider system 114 may access a database (e.g., database 212) storing a plurality of multi-source payment account profiles to identify the default allocation settings associated with the multi-source payment account profile indicated by the transaction request.

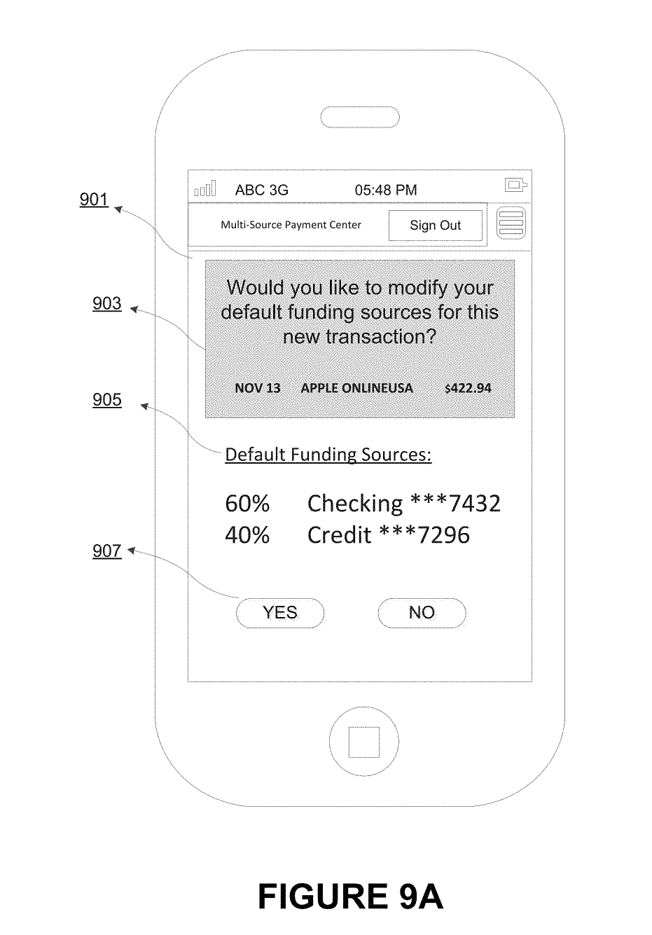

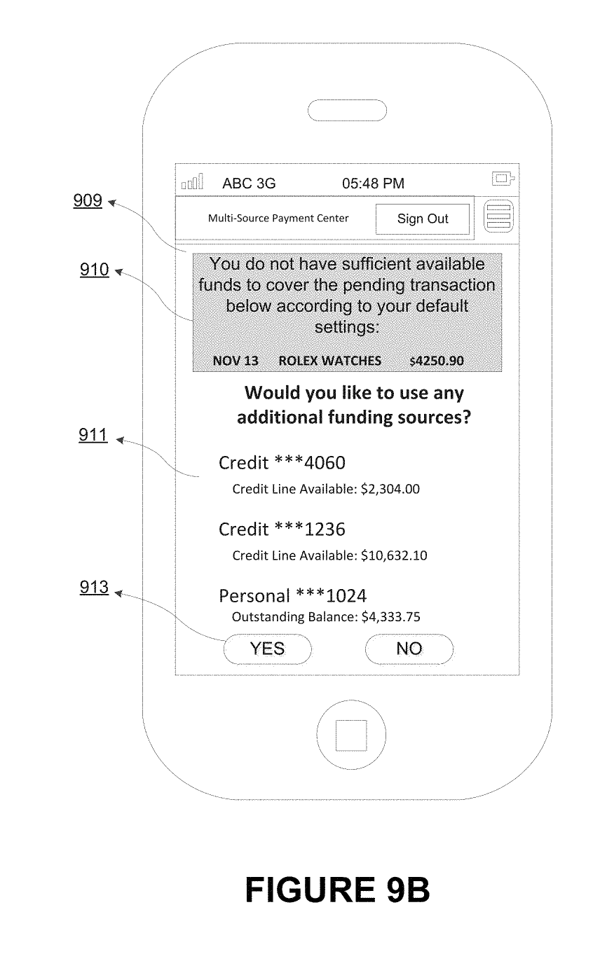

At step 604, multi-source transaction provider system 114 may determine whether the funding sources designated by the default allocation settings are sufficient to fund the transaction. If sufficient funds exist (step 604; YES), multi-source transaction provider system 114 may approve the transaction request (see also step 412; YES). If insufficient funds do not exist using the default allocation settings (step 604; NO), multi-source transaction provider system 114 may identify additional allocations and/or funding sources associated with the multi-source payment account to fund the purchase (step 606). For example, FIG. 9A depicts an exemplary user interface 901 on computing device 102. As depicted in FIG. 9A, multi-source transaction provider system 114 may transmit instructions to computing device 102 for displaying an interface 901 on computing device 102 requesting input from user 104 as to whether an alternative allocation of funds may be used to fund the purchase. In particular, interface 901 may include a window 903 identifying a particular transaction and asking whether the user would like to modify default funding sources 905 and/or their respective allocations. Interface 901 may further identify the default funding source(s) and allocations under the default allocation settings that are insufficient to fund transaction.

Additionally or alternatively, as noted above with respect to FIG. 6, multi-source transaction provider system 114 may suggest alternative funding allocations based on, for example, a determination that the user would qualify for a special promotion or other benefit by using another linked payment source or type of payment method. For example, multi-source transaction provider system 114 may determine that use of the other linked payment source to fund a transaction associated with a particular merchant would qualify the user for 5% cash back or other promotional offer. Indeed, in some embodiments, multi-source transaction provider system 114 may determine that the promotional offer will remain available during a future time period and suggest that the user establish the other payment source as the default payment source for that merchant during the future time period.

Interface 901 may also include button(s) 907 for receiving the user's selection. While button(s) is depicted as “yes” and “no” buttons, additional and/or alternative buttons, selectable elements, and/or fields are possible. For example, interface 901 may include fields corresponding to each default funding source allowing a user to operate computing device 102 in order to enter the new allocations for submission to multi-source transaction provider system 114. In some embodiments, where a P2P platform is employed as a funding source (by default or as an additional funding source), computing device 102 may further display an interface requesting an indication of whether to use an account balance associated with the P2P platform and/or whether to request funds from a third-party via the P2P platform.

Additionally or alternatively, FIG. 9B depicts another exemplary user interface 909 on computing device 102. As depicted in FIG. 9B, multi-source transaction provider system 114 may transmit instructions to computing device 102 for displaying an interface 909 requesting input from user 104 as to whether any alternative funding source(s) should be used instead of (or in addition to) the default funding sources. For example, user 104's default allocation settings may have identified only a subset of the potential payment sources (e.g., the potential payment sources identified at step 408 of FIG. 4) for a particular transaction or set of transactions, and multi-source payment account may identify the remaining potential payment sources at step 606. In some embodiments, interface 909 may include a window 910 identifying a particular transaction and noting that the default funding sources will not cover the transaction. Interface 909 may further include an area 911 asking whether the user would like to modify the default funding sources and/or their allocations with additional funding sources. Area 911 may further identify funding source(s) linked to a multi-source transaction profile available to include as a funding sources in addition or as an alternative to the default funding sources for the particular transition. Interface 909 may also include button(s) 913 for receiving a user's election to employ additional funding sources. While button(s) 913 are depicted as a “yes” and “no,” additional or alternative buttons, selectable elements, and/or fields are possible. For example, interface 909 may include fields corresponding to each funding source allowing a user to operate computing device 102 to enter the new allocations and/or funding sources for submission to multi-source transaction provider system 114.

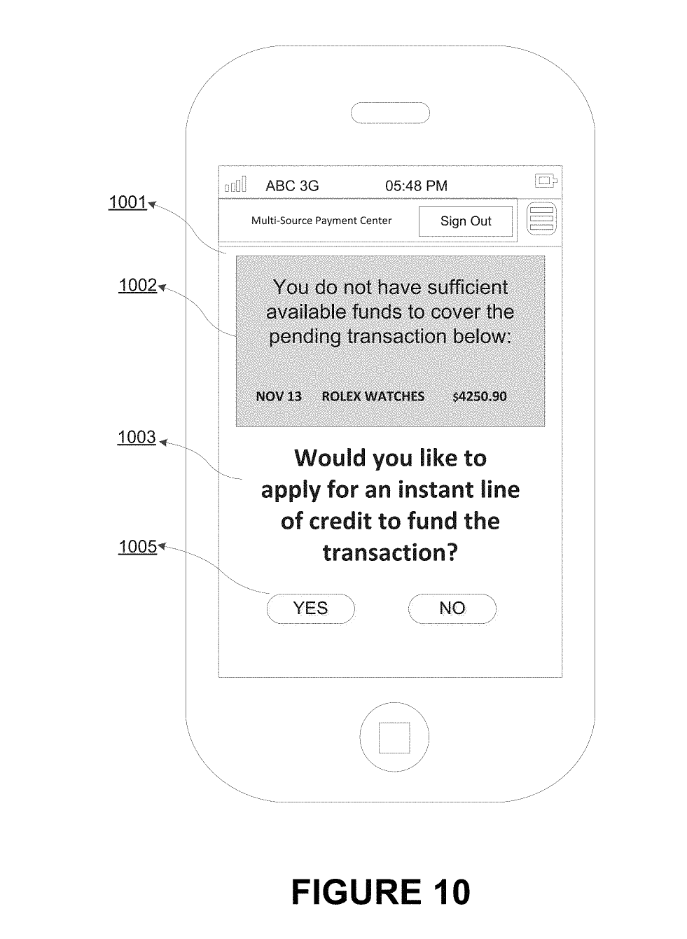

If additional funding sources and/or allocations are identified (and accepted by user 104) sufficient to fund the transaction (step 608; YES), multi-source transaction provider system 114 may approve the transaction request (see also step 412; YES). If insufficient funds exist (step 608; NO), multi-source transaction provider system 114 may offer additional funding options to fund the purchase (step 610). For example, FIG. 10 depicts an exemplary user interface 1001 on computing device 102. As depicted in FIG. 10, multi-source transaction provider system 114 may transmit instructions to computing device 102 for displaying an interface 1001 on computing device 102 requesting input from user 104 as to whether the user desire to apply for additional credit to fund the purchase. In particular, interface 1001 may include a window 1002 identifying a particular transaction and explaining that the funding sources linked to the multi-source payment account profile are insufficient to cover the purchase. Interface 1001 may further include an area 1003 asking whether user 104 would like to apply for additional credit to cover the transaction. The additional credit may be “instant” or “on demand” credit provided in real-time to fund a pending transaction.

The additional credit may comprise, for example, extending the credit limit of an existing credit account or opening a new credit account. Interface 1001 may also include button(s) 1005 for receiving the user's selection. While button(s) 1005 are depicted as “yes” and “no” buttons, additional and/or alternative buttons, selectable elements, and/or fields are possible. For example, interface 1001 may include a field for entering/selecting the amount of additional credit that user 104 wishes to apply for. In other embodiments, the additional credit may be automatically selected based on the particular transaction involved (e.g., the purchase amount for the particular transaction, the amount of additional credit required to fully fund the purchase, etc.). In some embodiments, the offer for additional funding options may become extended based on risk information associated with the purchase and/or user. For example, in some embodiments, multi-source transaction provider system 114 may access third-party system 118 associated with a credit bureau or valuation research company.

If additional funding sources are identified from user 104's acceptance of the offer for additional credit (step 612; YES), multi-source transaction provider system 114 may approve the transaction request (see also step 412; YES). If the user declines additional credit such that insufficient funds exist to cover the transaction (step 612; NO), multi-source transaction provider system 114 may decline the transaction.

After approving the transaction authorization request (step 614), multi-source transaction provider system 114 may allocate the funds across the funding sources according to the default allocation settings associated with the multi-source payment account profile (if approved via step 604), additional allocations and/or funding sources associated with the multi-source payment account (if approved via step 608), and/or additional funding options (if approved via 612). Additional details regarding the allocation of funds and reconciliation of financial accounts are discussed above with respect to step 416 of process 400.

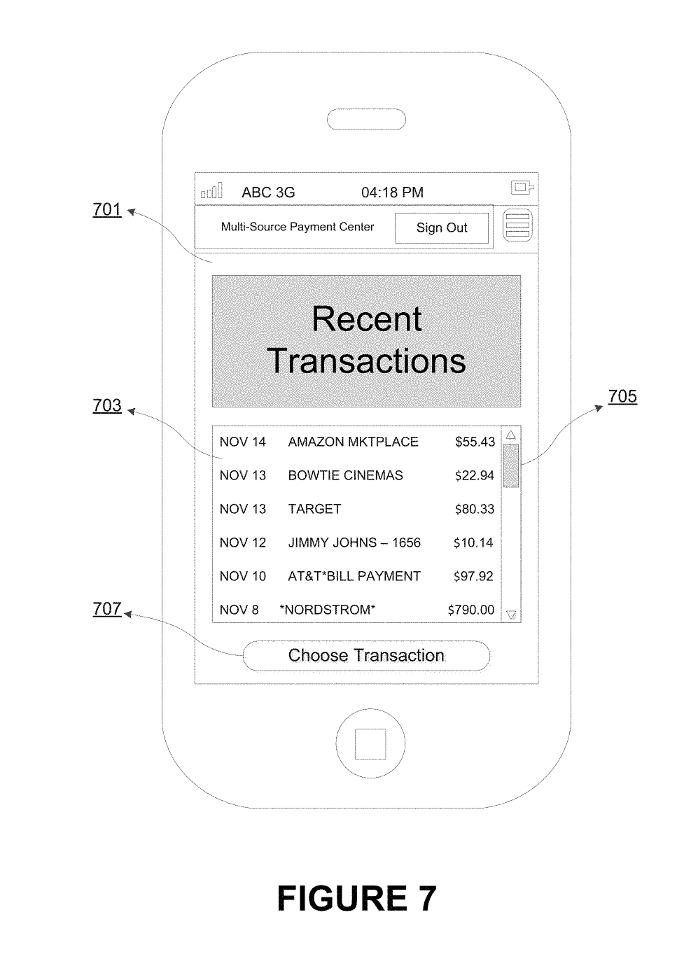

In some embodiments, after multi-source transaction provider system 114 has approved a transaction (see, e.g., step 614 and step 412; YES), multi-source transaction provider system 114 may receive a request to retroactively alter the funding sources associated with a purchase. For example, FIG. 7 depicts an exemplary user interface 701 on computing device 102. As depicted in FIG. 7, multi-source transaction provider system 114 may transmit instructions to computing device 102 for displaying interface 701 listing previously approved transactions that user 104 may select (via, e.g., input device 304 of computing device 102) in order to retroactively alter the funding sources. For example, interface 701 may include window 703 listing a plurality of approved transactions. Window 703 may also include a scrollbar 705 allowing user 104 to traverse the plurality of approved transactions when, for example, the list of transactions is not displayed in its entirety. After selecting one or more transactions from the list provided in window 703, user 104 may operate computing device 102 to activate button 707. In some embodiments, activation of button 707 may transmit identification of the selected one or more transactions to multi-source transaction provider system 114. Other means for identifying transactions for which user 104 wishes to alter the funding sources associated with a purchase are possible.

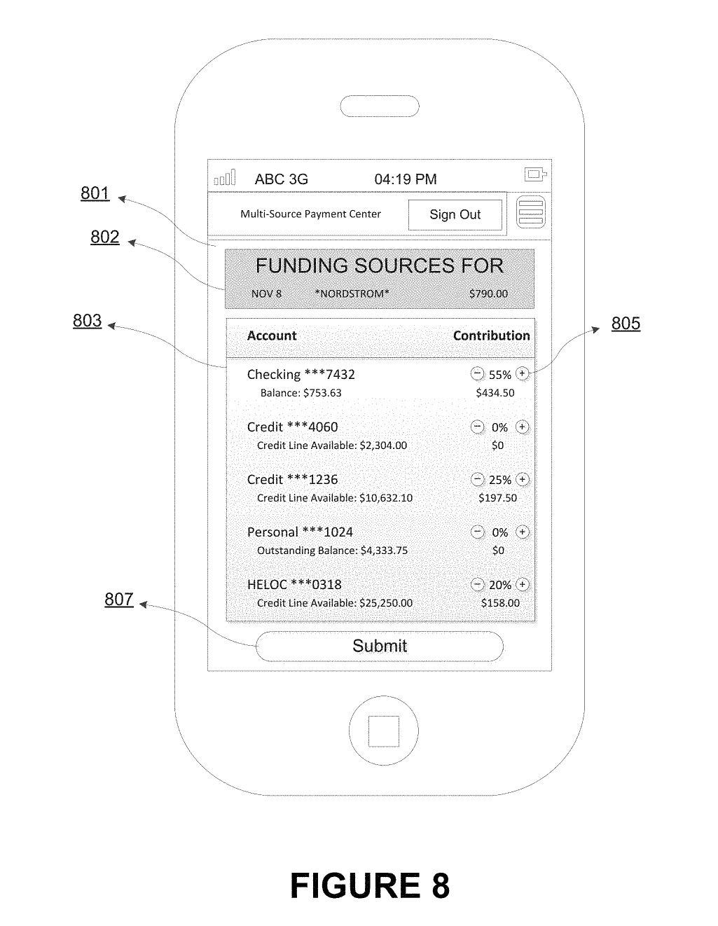

FIG. 8 depicts an exemplary user interface 801 on computing device 102. As depicted in FIG. 8, multi-source transaction provider system 114 may further transmit instructions to computing device 102 for displaying interface 801 for receiving user 104's alteration of the funding sources for a transaction. For example, interface 801 may include a window 802 identifying a particular transaction and a window 803 identifying a plurality of funding sources (e.g., all funding sources linked to user 104's multi-source payment account profile). Window 803 may further indicate the approved allocation of funds for the particular transaction identified in window 802.

Window 803 may further include buttons 805 (or other selectable elements) for adjusting the relative amount each funding source should be used to fund the purchase indicated in window 802. Interface 801 may also include a “submit” button 807 that, when selected, causes computing device 102 to transmit the adjusted allocation of funds to multi-source transaction provider system 114 for allocation. In some embodiments, multi-source transaction provider system 114 may receive the adjusted allocation after approving the transaction (e.g., step 614) but before allocating funds to cover the purchase (e.g., step 618). In other embodiments, multi-source transaction provider system 114 may receive the alteration of funds after allocating the funds, for example, according to default allocation settings associated with user 104's multi-source payment account profile, requiring adjustment/further reconciliation of the payment sources to comply with the adjusted allocation.

While several example interfaces are shown in FIGS. 7, 8, 9A, 9B, 10, 11A, and 11B, it will be understood that the interfaces shown are merely examples, and that other interfaces are possible as well.

The disclosed system provides a technical solution for funding purchases with multiple payment sources. In particular, the disclosed system allows a user to flexibly set and/or modify funding allocations according to different scenarios. For example, before a transaction occurs, according to user input, the disclosed system may set default allocation settings for certain transaction categories or set specific parameters (e.g., time, geographic limitation, etc.) used for a known incoming transaction. This is depicted in example FIGS. 11A and 11B. During a transaction, the disclosed system may allocate the transaction across the funding sources in real time based on the default allocation settings (e.g., drawing funds from a default checking account and simultaneously requesting a third party to share the expense via a P2P platform), allow the user to adjust the allocation settings, or apply a credit line to fund the transaction. This is depicted in example FIGS. 9A, 9B, and 10. After a transaction has settled, the disclosed system may allow the user to change the funding allocations for the settled transaction if there is an error with the previous allocation (e.g., miscategorization of the transaction) or the user's funding needs changes. This is depicted in example FIGS. 7 and 8.

In some examples, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those skilled in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments. For example, while a financial service provider and merchant have been referred to herein for ease of discussion, it is to be understood that consistent with disclosed embodiments other entities may provide such services in conjunction with or separate from a financial service provider and merchant.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or compact disc read-only memory CD-ROM, or other forms of random access memory (RAM) or read-only memory (ROM). Accordingly, the disclosed embodiments are not limited to the above described examples, but instead are defined by the appended claims in light of their full scope of equivalents.

What is claimed:

1. A device for allocating transactions across a plurality of sources, the device comprising:
a screen;
a memory storing instructions; and
a processor configured to execute the instructions to perform operations comprising:
displaying on the screen an interface for a multi-source payment account profile;
generating a first window in the interface indicating at least one characteristic of transactions and listing a plurality of potential payment sources available to include in a default allocation of funds settings associated with the multi-source payment account profile, the default allocation settings including at least one relative percentage at which the listed payment sources are used to fund transactions with the indicated at least one characteristic;
receiving a first user operation adjusting the relative percentages of the listed payment sources;
transmitting the adjusted relative percentages to a server over a communication network;
receiving from the server information regarding an approved transaction; and
switching the first window to a second window identifying the approved transaction and approved allocation of funds for the approved transaction.

2. The device of claim 1, wherein the operations further comprise:
receiving from the server a message indicating that the default allocation of funds does not cover a purchase associated with an electronic transaction authorization request;
based on the message, generating, in the interface, a prompt including at least one alternative allocation of funds which covers the purchase;
receiving a second user operation selecting an alternative allocation of funds; and
transmitting the selected alternative allocation of funds to the server, wherein the server authorizes the electronic transaction authorization request based on the selected alternative allocation of funds.

3. The device of claim 1, wherein the operations further comprise:
receiving a second user operation altering the approved allocation of funds;
generating a revised allocation of funds for funding the approved transaction; and
transmitting the revised allocation of funds to the server, wherein the server reconciles the plurality of potential payment accounts to fund the purchase according to the revised allocation of funds.

4. The device of claim 1, wherein the operations further comprise:
receiving from the server a message indicating that the default allocation of funds does not cover a purchase associated with an electronic transaction authorization request;
based on the message, disabling a payment feature associated with the electronic transaction authorization request.

5. The device of claim 1, wherein:
the approved transaction is a first approved transaction; and
the operations further comprise:
before receiving the information regarding the first approved transaction, generating a third window listing a plurality of approved transactions; and
receiving a third user operation selecting the first approved transaction in the third window;
transmit to the server a request for information regarding the first approved transaction; and
receiving from the server information regarding at least one allocation for the first approved transaction.

6. A system for allocating transactions across a plurality of sources, the system comprising:
a memory storing instructions; and
a processor configured to execute the instructions to perform operations comprising:
receiving, over a payment processing network, an electronic transaction authorization request originating from a merchant server;
identifying a multi-source payment account profile from among a plurality of multi-source payment account profiles stored in a database based on the received electronic transaction authorization request;
identifying a plurality of potential payment sources linked to the multi-source payment account profile based on the received electronic transaction authorization request;
determining a response to the received electronic transaction authorization request based on at least the identified plurality of potential payment sources and a purchase amount associated with the received electronic transaction authorization request; and
transmitting, over the payment processing network, the response to the merchant server.

7. The system of claim 6, wherein:
the operations further comprise:
accessing a plurality of default allocation settings associated with the multi-source payment account profile; and
identifying a default allocation of funds from among the identified plurality of potential payment sources based on the plurality of default allocation settings and at least one characteristic of the electronic transaction authorization request;
determining the response further comprises determining the default allocation of funds covers a purchase associated with the electronic transaction authorization request, and
transmitting the response further comprises authorizing the received electronic transaction authorization.

8. The system of claim 7, wherein the operations further comprise:
initiating reconciliation of the plurality of potential payment accounts to fund the purchase according to the determined allocation of funds.

9. The system of claim 6, wherein the operations further comprise:
accessing a plurality of default allocation settings associated with the multi-source payment account profile;
identifying a default allocation of funds from among the identified plurality of potential payment sources based on the plurality of default allocation settings and at least one characteristic of the electronic transaction authorization request;
determining the default allocation of funds does not cover a purchase associated with the electronic transaction authorization request;
transmitting, to a mobile device, instructions to display an interface on the mobile device presenting at least one alternative allocation of funds that covers the purchase;
receiving, from the mobile device, an indication that a user operating the mobile device selected an alternative allocation of funds; and
authorizing the received electronic transaction authorization request based on the received indication.

10. The system of claim 6, wherein the operations further comprise:
accessing a plurality of default allocation settings associated with the multi-source payment account profile;
identifying a default allocation of funds from among the identified plurality of potential payment sources based on the plurality of default allocation settings and at least one characteristic of the electronic transaction authorization request;
determining the default allocation of funds does not cover a purchase associated with the electronic transaction authorization request; and
transmitting, to a mobile device, instructions to display an interface on the mobile device presenting credit options for funding the purchase.

11. The system of claim 6, wherein the operations further comprise:
accessing a plurality of default allocation settings associated with the multi-source payment account profile; and
from among the identified plurality of potential payment sources, selecting a first default allocation of funds when the purchase amount is below a first threshold and selecting a second default allocation of funds when the purchase amount meets or exceeds a second threshold.

12. The system of claim 6, wherein the operations further comprise:
accessing a plurality of default allocation settings associated with the multi-source payment account profile; and
identifying a default allocation of funds based on a merchant associated with the electronic transaction authorization request.

13. The system of claim 6, wherein the operations further comprise:
extracting a transaction account number from the electronic transaction authorization request;
accessing the database storing the plurality of multi-source payment account profiles; and
determining the multi-source payment account profile includes the transaction account number as a linked potential payment source.

14. The system of claim 6, wherein the operations further comprise:
receiving, from a mobile device subsequent to the transmitting of the response to the merchant server, a request to alter an allocation of funds for a purchase associated with the electronic transaction authorization request;
providing, to the mobile device, instructions to display an interface on the mobile device presenting a listing of the identified plurality of funding sources;
receiving, from the mobile device, an indication that a user operating the mobile device selected a revised allocation of funds for funding the purchase; and
initiating reconciliation of the plurality of potential payment accounts to fund the purchase according to the revised allocation of funds.

15. The system of claim 6, wherein the operations further comprise:
accessing a plurality of default allocation settings associated with the multi-source payment account profile;
identifying a default allocation of funds from among the identified plurality of potential payment sources based on the plurality of default allocation settings and at least one characteristic of the electronic transaction authorization request;
determining the default allocation of funds does not cover a purchase associated with the electronic transaction authorization request; and
disabling a payment feature associated with a mobile device operated by a user associated with the electronic transaction authorization request.

16. A computer-implemented method for allocating transactions across a plurality of sources, the method comprising:
receiving, over a payment processing network, an electronic transaction authorization request originating from a merchant server;
identifying a multi-source payment account profile from among a plurality of multi-source payment account profiles stored in a database based on the received electronic transaction authorization request;
identifying a plurality of potential payment sources linked to the multi-source payment account profile based on the received electronic transaction authorization request;
determining a response to the received electronic transaction authorization request based on at least the identified plurality of potential payment sources and a purchase amount associated with the received electronic transaction authorization request; and
transmitting, over the payment processing network, the response to the merchant server.

17. The method of claim 16, further comprising:
accessing a plurality of default allocation settings associated with the multi-source payment account profile; and
identifying a default allocation of funds from among the identified plurality of potential payment sources based on the plurality of default allocation settings and at least one characteristic of the electronic transaction authorization request;
wherein determining the response further comprises determining the default allocation of funds covers a purchase associated with the electronic transaction authorization request, and
wherein transmitting the response further comprises authorizing the received electronic transaction authorization.

18. The method of claim 16, further comprising:
accessing a plurality of default allocation settings associated with the multi-source payment account profile;
identifying a default allocation of funds from among the identified plurality of potential payment sources based on the plurality of default allocation settings and at least one characteristic of the electronic transaction authorization request;
determining the default allocation of funds does not cover a purchase associated with the electronic transaction authorization request;
transmitting, to a mobile device, instructions to display an interface on the mobile device presenting at least one alternative allocation of funds that covers the purchase;
receiving, from the mobile device, an indication that a user operating the mobile device selected an alternative allocation of funds; and
authorizing the received electronic transaction authorization request based on the received indication.

19. The method of claim 16, further comprising:
accessing a plurality of default allocation settings associated with the multi-source payment account profile;
identifying a default allocation of funds from among the identified plurality of potential payment sources based on the plurality of default allocation settings and at least one characteristic of the electronic transaction authorization request;
determining the default allocation of funds does not cover a purchase associated with the electronic transaction authorization request; and
transmitting, to a mobile device, instructions to display an interface on the mobile device presenting credit options for funding the purchase.

20. The method of claim 16, further comprising:
receiving, from a mobile device subsequent to the transmitting of the response to the merchant server, a request to alter an allocation of funds for a purchase associated with the electronic transaction authorization request;
providing, to the mobile device, instructions to display an interface on the mobile device presenting a listing of the identified plurality of funding sources;
receiving, from the mobile device, an indication that a user operating the mobile device selected a revised allocation of funds for funding the purchase; and
initiating reconciliation of the plurality of potential payment accounts to fund the purchase according to the revised allocation of funds.
